(19) United States
(12) Patent Application Publication
(10) Pub. No.: US 2025/0167266 A1
(43) Pub. Date: May 22, 2025

(54) Blade Structure, Water Gas Separator and Fuel Cell

(71) Applicant: Robert Bosch GmbH, Stuttgart (DE)

(72) Inventors: Dachao Fan, Wuxi (CN); Meng Zhao, Wuxi (CN); Shuai Gao, Wuxi (CN); Xueling Qian, Wuxi (CN); Yibo Chen, Wuxi (CN)

(21) Appl. No.: 18/938,848

(22) Filed: Nov. 6, 2024

(30) Foreign Application Priority Data
Nov. 17, 2023 (CN) 2023 2311 5350.6

(51) Int. Cl. H01M 8/04119; B01D 45/08

(52) U.S. Cl. CPC H01M 8/04164; B01D 45/08

(57) ABSTRACT

A blade structure for a water gas separator of a fuel cell includes (i) a cylindrical body, (ii) a plurality of blades adapted to separate moisture from gas in an air flow, the plurality of blades extending independently and separately from an outer surface of the cylindrical body outwardly and in a separation relationship between at least two adjacent blades outside an area of the cylindrical body, and (iii) a retaining structure formed on the blade that allows the blade structure to be retained in a water gas separator. The blade structure of the water gas separator of the fuel cell is simplified, more convenient for processing and manufacturing, less costly to manufacture, and in some examples the press-fit installation of the existing blade structure is removed, making installation of the blade structure in the water gas separator easier and more stable.

This application claims priority under 35 U.S.C. § 119 to patent application no. CN 2023 2311 5350.6, filed on Nov. 17, 2023 in China, the disclosure of which is incorporated herein by reference in its entirety.

The present application relates to the field of fuel cell technology, in particular, to a blade structure, a water gas separator, and a fuel cell.

### BACKGROUND

In a fuel cell system, as the battery reaction proceeds, water is constantly generated, and once the water is brought into the gas channel, the water content in the channel will be too high, causing the performance of the fuel cell system to degrade significantly or even unable to work normally. To avoid this situation, a water gas separator is needed in the fuel cell system to separate moisture in the air flow.

The water gas separator includes a blade structure having a plurality of blades. As the airflow passes through the blade structure, the resulting centrifugal force causes moisture to be deposited on the blade surface and the gas to continue to flow due to the structural design of the blade and the action of the hydrodynamic principles. As such, separation of moisture and gas can be achieved. The blade structure typically requires separate manufacture and then assembly into a respective housing to form a water gas separator. Thus, the construction and manufacturing method of the blade structure itself is critical to the overall manufacturing difficulty and manufacturing cost of the water gas separator.

### SUMMARY

An object of the present application is to provide an improved blade structure for a water gas separator of a fuel cell, where the blade structure is simpler in structure, easier in manufacturing and easier in assembly than existing blade structures.

According to a first aspect of the present application, a blade structure for a water gas separator of a fuel cell is provided, the blade structure comprising: a cylindrical body; a plurality of blades adapted to separate moisture from gas in an air flow, the plurality of blades extending independently and separately from an outer surface of the cylindrical body outwardly and in a separate relationship between at least two adjacent blades outside an area of the cylindrical body; and a retaining structure formed on the blade that allows the blade structure to be retained in a water gas separator.

According to one optional example of the present application, there is a separation relationship between any two adjacent blades of the plurality of blades.

According to one optional example of the present application, at least one of the plurality of blades has an end projection formed at a lobe edge that is away from the cylindrical body thereof.

According to one optional example of the present application, the end projection is integrally molded with the lobe edge.

According to one optional example of the present application, the end projection has a thickness greater than that of the lobe edge in an area adjacent the end projection.

According to one optional example of the present application, each of the blades extends outwardly in a helical shape from the outer surface of the cylindrical body.

According to one optional example of the present application, the plurality of blades are integrally molded with the cylindrical body.

According to one optional example of the present application, the plurality of blades and the cylindrical body are made of a metal material.

According to one optional example of the present application, the cylindrical body has a cavity inside.

According to a second aspect of the present application, a water gas separator for a fuel cell is provided, the water gas separator comprising: the blade structure according to the first aspect of the present application; and a housing receiving the blade structure.

According to one optional example of the present application, an interior wall of the housing has a recess adapted to receive the end projection of the blade structure therein.

According to one optional example of the present application, the blade structure is assembled into the housing such that the end projection of the blade is positioned downstream in a flow direction of an air flow in the housing.

According to one optional example of the present application, the housing has a first component and a second component that are separate from each other, the first component and the second component being configured to collectively form the recess in an assembled state.

According to one optional example of the present application, the first component has a step at a top, the step being adapted to support the end projection of the blade structure.

According to one optional example of the present application, a bottom portion of the second component is partially pressed against the end projection of the blade structure.

According to a third aspect of the present application, a fuel cell is provided, and the fuel cell includes the blade structure according to the first aspect of the present application or the water gas separator according to the second aspect of the present application.

The blade structure according to the example of the present application removes a joining structure of adjacent blades outside the area of the cylindrical body, particularly a ring cartridge structure at the blade edges connecting the blades, etc., as compared to an existing blade structure for a water gas separator of a fuel cell, thus simplifying the blade structure, making it easier to process and manufacture the blade structure, making it less costly to manufacture, and avoiding the press-fit installation of existing blade structure through the structure design of the blades, making the assembly of the blade structure simpler in the water gas separator, and improving the system stability of the water separator.

### BRIEF DESCRIPTION OF THE DRAWINGS

In the following, the present application is described in greater detail with reference to the accompanying drawings to provide a better understanding of its principles, features, and advantages. In the accompanying drawings,

FIG. 1 shows a cross-sectional view of an existing water gas separator and a stereoscopic view of a blade structure thereof;

FIG. 2 shows a stereoscopic view of a blade structure according to one exemplary example of the present application;

FIG. 3 illustrates a cross-sectional view of a water gas separator according to one exemplary example of the present application; and

FIG. 4 shows a stereoscopic view of a blade structure according to another exemplary example of the present application.

### LIST OF REFERENCE NUMERALS

10, 10′ blade structure
1, 1′ cylindrical body
11 cavity
2, 2′ blade
21, 21′ lobe edge
22′ ring cartridge structure
23 end projection
100, 100′ water gas separator
30, 30′ housing
31 first component
32 second component
301 recess
311 step

### DETAILED DESCRIPTION

To provide a clearer understanding of the technical problems, technical solutions, and beneficial technical effects to be addressed by the present application, the following detailed description of the present application will be provided with reference to the accompanying drawings and multiple exemplary examples. It should be understood that the specific examples described herein are provided solely for the purpose of explaining the principles of the present application and not for limiting the scope of protection of the present application.

In the accompanying drawings of the present application, features with similar structures or functions are indicated by the same reference numerals. The accompanying drawings are not strictly drawn to scale but are enlarged for clarity purposes.

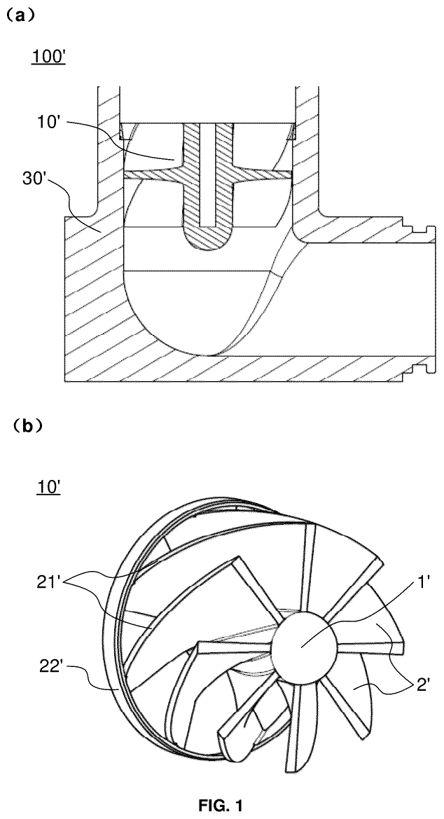

FIG. 1 shows, by way of example, a cross-sectional view (a) of an existing water gas separator 100′, as well as a stereoscopic view (b) of a blade structure 10′ thereof. As shown in FIG. 1, the water gas separator 100′ includes a blade structure 10′ and a housing 30′. The blade structure 10′ includes a cylindrical body 1′ and a plurality of blades 2′ extending independently and separately from an outer surface of the cylindrical body 1′ outwardly. As the air flow with moisture flows from upstream of the housing 30′ (i.e., along the flow direction from bottom to top shown in the (a) portion of FIG. 1) to the blade structure 10′, moisture in the air flow will deposit on the surface of the blade 2′ and drip from the surface of the blade 2′ below the blade structure 10′ upon condensation. The gas separated from moisture continues to flow upwardly, flowing through the blade structure 10′, and to the exterior of the housing 30′ or the water gas separator 100′. As such, the water-gas separation function can be achieved.

As shown in the (b) portion of FIG. 1, the blade structure 10′ also includes a ring cartridge structure 22′ that connects the tail ends of each of the plurality of blades 2′, i.e., the lobe edges 21′ away from the cylindrical body 1′. In addition, when the blade structure 10′ is installed into the water gas separator 100′, a press-fit manner is typically employed to secure the blade structure 10′ to the interior of the water gas separator 100′. Upon assembly, the ring cartridge structure 22′ of the blade structure 10′ conforms to the interior wall of the housing 30′. Typically, depending on the base material of the blade structure 22′, the blade structure 10′ with a ring cartridge structure 22′ may be manufactured using processes such as soldering connections, integrated injection molding, and 3D printing. However, due to the presence of the ring cartridge structure 22′, such a blade structure 10′ tends to be difficult to manufacture and/or machine, resulting in higher manufacturing costs for the blade structure 10′, which in turn increases the manufacturing costs for the water gas separator 100′. In addition, when the blade structure 10′ is installed by press-fit, there is also a problem of unstable press-fit force between the blade structure 10′ and the housing 30′, and even a risk in system reliability of the water gas separator 100′ will occur.

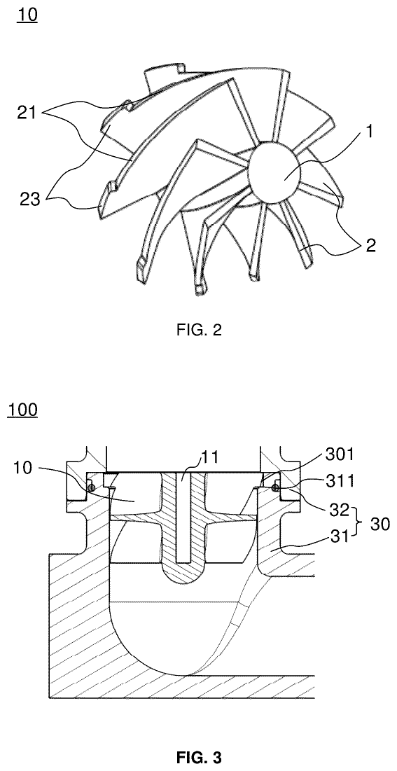

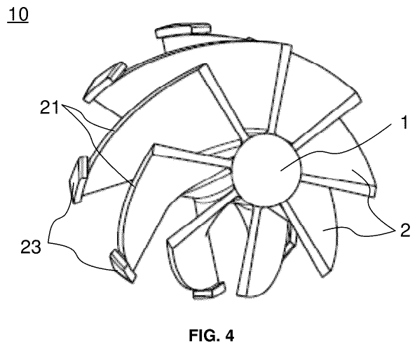

FIG. 2 shows a stereoscopic view of a blade structure according to one exemplary example of the present application. FIG. 3 shows a cross-sectional view of a water gas separator according to one exemplary example of the present application. The technical solutions of the present application will be described in detail below in conjunction with FIGS. 2 and 3.

As shown in FIG. 2, the blade structure 10 according to the present application includes a cylindrical body 1, a plurality of blades 2, and a retaining structure formed on the blade 2 that allows the blade structure 10 to be retained in the water gas separator 100. The plurality of blades 2 extend outwardly from an outer surface of the cylindrical body 1 independently and separately from one another. Unlike the prior art, there is a separation relationship between at least two adjacent blades 2 outside the area of the cylindrical body 1. That is, the blade structure 10 according to an example of the present application removes the ring cartridge structure 22′ as compared to the blade structure 10′ shown in the (b) portion of FIG. 1. In addition, there are no other interconnecting structures between the at least two adjacent blades 2 outside the area of the cylindrical body 1.

By removing the joining structure of adjacent blades 2 outside the area of the cylindrical body 1, such as the ring cartridge structure 22′, the structure of the blade structure 2 may be made simpler, thereby simplifying its processing and manufacturing processes, reducing manufacturing costs, and being suitable for mass production.

In some optional examples, there is a separation relationship between any two adjacent blades 2 of the plurality of blades 2. As such, there is no connecting structure between the various blades that can connect adjacent blades, making the blade structure 10 simpler and more balanced.

Exemplarily, as shown in FIGS. 2 and 3, each blade 2 extends outwardly in a helical shape from the outer surface of the cylindrical body 1. The helical blade shape may increase the cross-sectional area of the blade 2 in the direction of flow of the air flow with moisture, allowing the airflow flowing to the blade structure 10 to more contact the surface of the blade 2, thereby facilitating more moisture condensation and removal on the blade 2 surface, providing better separation of moisture.

Preferably, the plurality of blades 2 may be integrally molded with the cylindrical body 1. The spacing or space between the lobe edges 21 of adjacent blades 2 is greater than the connection area of the blade 2 to the cylindrical body 1, which may provide greater room for machining and increase operational flexibility. Thus, in some examples, the blade 2 may be machined to form a respective end projection 23 after the blade 2 is integrally molded with the cylindrical body 1.

Optionally, in some examples, the plurality of blades 2 and the cylindrical body 1 are made of a metal material. In this way, good thermal conductivity of the metallic material can be utilized to facilitate moisture condensation and water gas separation, and it is also possible to provide the convenience of machining for the manufacture of the blade structure.

Additionally, or alternatively, the cylindrical body 1 may have a cavity 11 inside. Setting the cavity 11 may provide for a weight reduction of the cylindrical body 1 in one aspect, and may be used to receive additional insertion components for counterweighting in another aspect. Accordingly, weight adjustment of the cylindrical body 1 may be achieved by disposing the cavity 11 inside the cylindrical body 1, thereby enabling weight adjustment of the blade structure 10. As shown in FIG. 3, the cavity 11 may extend along a longitudinal axis of the cylindrical body 1. However, the present application is not limited thereto, and any cavity or similar structure capable of achieving the functions described above may be considered as the cavity 11 in the present application.

The blade structure 2 according to an example of the present application may be assembled into the housing 30 for the water gas separator 100 in some examples by press-fit. However, more preferably, in some examples, as shown in FIG. 2, at least one blade 2 of the plurality of blades 2 has an end projection 23 formed at the lobe edge 21 thereof away from the cylindrical body 1. The end projection 23 may act as a retaining structure to retain the blade structure 10 in the water gas separator 100.

To this end, as shown in FIG. 3, a recess 301 may be provided accordingly at an interior wall of housing 30 for receiving the end projection 23 of the blade structure 10 therein. The blade structure 10 may be secured in the housing 30 by disposing the end projection 23 and the corresponding recess 301 to receive the end projection 23 into the recess 301.

In some optional examples, the end projection 23 is integrally molded with the lobe edge 21. As such, possible stress concentration between the end projection 23 and the lobe edge 21 may be avoided. For example, the blade structure 10 with the end projection 23 may be made by designing an injection molding mold using an integrated injection molding process. Alternatively, for the blade structure 10 made of a metal or alloy, the lobe edge 21 may be cut to remove the excess edge portion to form the end projection 23. To this end, a dimension range for forming the end projection 23 may be reserved during the formation of the blade 2.

In some optional examples, the lobe edge 21 and the end projection 23 may transition in a manner where the thickness changes continuously. Alternatively, the end projection 23 may have a thickness that is greater than the thickness of the lobe edge 2 in an area adjacent the end projection 23. FIG. 4 shows a stereoscopic view of such a blade structure, with the end projection 23 having a greater thickness than that of other portions of the blade 2, as shown in FIG. 4. By increasing the thickness of the end projection 23, the end projection 23 may be allowed to mate with the respective recess 301 with a greater contact area when the blade structure 10 is assembled into the housing 30 of the water gas separator 100, thereby further increasing the retention stability of the blade structure 10.

In some examples, the recess 301 is disposed on an interior wall of the housing 30 of the water gas separator 100, which may be implemented by a slotting or other process. More preferably, in some examples, as shown in FIG. 3, the housing 30 has a first component 31 and a second component 32 that are separate from each other, the first component 31 and the second component 32 being configured to collectively form the recess 301 in an assembled state. In particular, the first component 31 and the second component 32 may form the recess 301 at an interior wall at the mating ends thereof through a profile of the corresponding mating ends. In this way, the first component 31 and the second component 32 may be conveniently processed on their end surfaces so as to be capable of providing the desired recess 301 by fitting profiles of the end surfaces, respectively. Compared with the above-mentioned process of opening a recess on the interior wall of the integral housing 30, the processing of the recess 301 may be further simplified and the mounting of the blade structure 10, particularly the mating of the end projection 23 with the recess 301, is simplified.

When the blade structure 10 is assembled into the housing 30, the end projection 23 thereof is positioned downstream of the flow direction of the airflow in the housing 30. For example, as shown in FIG. 3, the end projection 23 of the blade structure 10 is placed on the step 311 in the illustrated up-to-down direction such that the step 311 supports the end projection 23, and further supports the blade structure 10. As such, the blade structure 10 and then the second component 32 can be placed onto the first component 31 very conveniently to form a fit, thereby achieving assembly among the three in a simple manner. Additionally, at locations downstream of the flow direction of the airflow in the housing 30, the water content in the airflow has been reduced, which may thereby facilitate the structure of the end projections 23 and respective recesses 301 and the connections therebetween.

The blade structure according to the present application removes the joining structure of adjacent blades 2 outside the area of the cylindrical body 1 in the existing blade structure, particularly the ring cartridge structure connecting the respective blades together at the lobe edges of the blades, making the blade structure simpler, which makes it easier to process and manufacture the blade structure, less costly to manufacture, and in some examples, the press-fit installation of the existing blade structure has been removed, making the installation of the blade structure in the water gas separator easier and more stable.

It is worth mentioning that in this document, terms such as “first,” “second,” etc., are used for descriptive purposes only and should not be construed as indicating or implying relative importance. Furthermore, such terms should not be understood as implying a specific quantity of the indicated technical features. Features described with “first,” “second,” etc., can explicitly or implicitly represent the inclusion of at least one of that feature.

In addition, in the description of the present application, the terms “installing,” “connecting,” etc., unless expressly specified and defined otherwise, shall be broadly understood, e.g., may be fixed mounting/connecting, removable mounting/connecting, or integrally mounting/connecting; may be direct mounting/connecting, or may be indirectly installing/connecting through intermediate media, and may also allow communication within two elements. For those of ordinary skill in the art, the specific meaning of the above terms in the present application can be understood in a specific context.

What is claimed is:

1. A blade structure for a water gas separator of a fuel cell, comprising:
a cylindrical body;
a plurality of blades configured to separate moisture from gas in an air flow, the plurality of blades extending independently and separately from an outer surface of the cylindrical body outwardly and in a separate relationship between at least two adjacent blades outside an area of the cylindrical body; and
a retaining structure formed on the blade and configured to allow the blade structure to be retained in the water gas separator.

2. The blade structure according to claim 1, wherein any two adjacent blades of the plurality of blades are in a separation relationship.

3. The blade structure according to claim 1, wherein at least one of the plurality of blades has an end projection formed at a lobe edge that is away from the cylindrical body thereof.

4. The blade structure according to claim 3, wherein:
the end projection is integrally molded with the lobe edge; and/or
a thickness of the end projection is greater than a thickness of the lobe edge in an area adjacent the end projection.

5. The blade structure according to claim 1, wherein:
each of the blades extends outwardly in a helical shape from the outer surface of the cylindrical body; and/or
the plurality of blades are integrally molded with the cylindrical body; and/or
the plurality of blades and the cylindrical body are made of a metal material; and/or
the cylindrical body has a cavity inside.

6. A water gas separator for a fuel cell, comprising:
the blade structure according to claim 1; and
a housing configured to receive the blade structure.

7. The water gas separator according to claim 6, wherein:
an interior wall of the housing has a recess configured to receive the end projection of the blade structure therein; and/or
the blade structure is assembled into the housing such that the end projection of the blade is positioned downstream in a flow direction of an air flow in the housing.

8. The water gas separator according to claim 7, wherein the housing has a first component and a second component that are separate from each other, the first component and the second component being configured to collectively form the recess in an assembled state.

9. The water gas separator according to claim 8, wherein:
the first component has a step at a top, the step being adapted to support the end projection of the blade structure; and/or
a bottom portion of the second component is partially pressed against the end projection of the blade structure.

10. A fuel cell, comprising:
a blade structure for a water gas separator of the fuel cell including (i) a cylindrical body, (ii) a plurality of blades configured to separate moisture from gas in an air flow, the plurality of blades extending independently and separately from an outer surface of the cylindrical body outwardly and in a separate relationship between at least two adjacent blades outside an area of the cylindrical body, and (iii) a retaining structure formed on the blade and configured to allow the blade structure to be retained in the water gas separator; and
a housing configured to receive the blade structure.
